(19) United States
(12) Patent Application Publication
(10) Pub. No.: US 2015/0112981 A1
(43) Pub. Date: Apr. 23, 2015

(54) Entity Review Extraction

(71) Applicants: Ivan Monteiro de Castro Conti, Belo Horizonte (BR); Diego Lopes Nogueira, Sabara (BR)

(72) Inventors: Ivan Monteiro de Castro Conti, Belo Horizonte (BR); Diego Lopes Nogueira, Sabara (BR)

(73) Assignee: Google Inc.

(21) Appl. No.: 12/637,440

(22) Filed: Dec. 14, 2009

(51) Int. Cl. G06F 17/00; G06F 17/30; G06N 5/02

(52) U.S. Cl. CPC G06F 17/30675
USPC 707/730; 715/231; 706/54; 707/E17.047

(57) ABSTRACT

Methods, systems, and apparatus, including computer programs encoded on a computer storage medium, for entity review extraction. In one aspect, a method includes receiving documents identified as containing potential reviews of entities and extracting individual review candidates from one or more of the received documents wherein each individual review candidate contains at most one review and providing one or more of the review candidates to a sentiment analysis process wherein the sentiment analysis process is configured to calculate a sentiment magnitude for each of the review candidates based on words in the review candidates.

### BACKGROUND

Local search engines are search engines that attempt to return relevant web pages and/or business listings within a certain distance of a specific geographic location. For a local search, a user may enter a search query and may specify a geographic location around which the search query is to be performed. The local search engine may return relevant results, such as relevant web pages pertaining to the geographic area or listings of businesses that are located within a certain distance of a center of the specified geographic location. For example, if one searches for restaurants in San Francisco using an existing graphical map search interface only the most relevant restaurants within a certain distance of the very center point of the map will be provided to the searching user.

### SUMMARY

This specification describes technologies relating to identifying and presenting reviews of entities in documents.

In general, one aspect of the subject matter described in this specification can be embodied in a method that includes a method, comprising: receiving documents identified as containing potential reviews of entities and extracting individual review candidates from one or more of the received documents wherein each individual review candidate contains at most one review; providing one or more of the review candidates to a sentiment analysis process wherein the sentiment analysis process is configured to calculate a sentiment magnitude for each of the review candidates based on words in the review candidates; selecting one or more of the provided reviews whose sentiment magnitude satisfies a metric; and associating the selected reviews with entities identified in the documents from which the reviews were extracted. Other embodiments of this aspect include corresponding systems, apparatus, and computer program products.

These and other aspects can optionally include one or more of the following features. The documents can be identified as containing the potential reviews by a classifier. Extracting the reviews can comprise locating entity identifying information in the received documents. The extracted review can occur in proximity to entity identifying information in a received document. The extracted review can occur between two markup language tags and has no intervening markup language tags. The extracted review can occur between two markup language tags in a first set of tags and has no intervening markup language tags other than one or more tags from a different second set of tags. The entity identifying information can include one or more of: a telephone number, a business name, an address, and an image. Associating the selected reviews with entities can be based on the entity identifying information in the documents. Selecting provided reviews whose sentiment magnitude satisfies a metric can comprise classifying the extracted reviews using a lexicon in order to determine a respective magnitude for each extracted review.

Particular embodiments of the subject matter described in this specification can be implemented so as to realize one or more of the following advantages. Techniques described herein can be used to create a database of business listing reviews from the world wide web or other source of information. Individual reviews are identified, extracted, and segmented from the documents separately. Sentiment analysis can be used to improve the quality of review results that are shown in the reviews section of a business listing. A sentiment analysis threshold is used to filter out potential reviews which are mostly likely not actual reviews. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates entity reviews as displayed in an example web page as presented in a web browser or other software application.

FIG. 2 illustrates an example process for entity review extraction.

FIG. 3 illustrates a hypertext markup language document.

FIG. 4 is a flow diagram of an example technique for entity review extraction.

FIG. 5 is a schematic diagram of an example system configured to perform entity review extraction.

Like reference numbers and designations in the various drawings indicate like elements.

### DETAILED DESCRIPTION

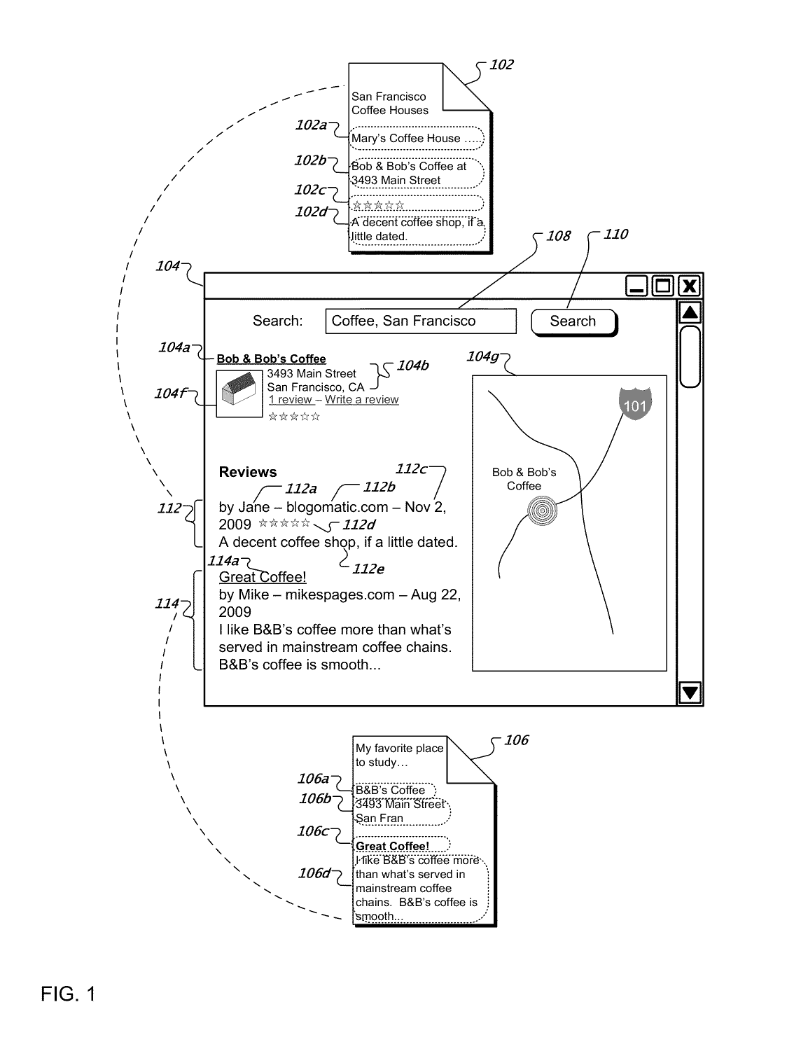

FIG. 1 illustrates entity reviews as displayed in an example web page 104 as presented in a web browser or other software application. An entity is a place or a thing such as, for example, a business or a landmark. Other entities are possible, however. An entity review is an opinion of an entity. The web page 104 includes a text entry field 108 which accepts entity queries from users when a search button 110 is selected. By way of illustration, users can enter queries that specify a general or specific geographic location, and an entity name or description of a product or service. Entities that are responsive to queries are presented below the text entry field 108. For example, business entity Bob & Bob's Coffee is responsive to the entity query “Coffee, San Francisco” because it is a business that sells coffee in San Francisco. The web page 104 includes entity identifying information that identifies the entity such as, for instance, a business name 104a, a business address 104b, and a photograph 104f of the business. Other entity identifying information is possible, however. Adjacent to the entity identifying information is a map 104g that depicts the location of the Bob & Bob's Coffee based on the address 104b.

The web page 104 also includes customer reviews 112 and 114 of Bob & Bob's Coffee that were automatically extracted from other electronic documents such as web pages 102 and 106. An electronic document (which for brevity will simply be referred to as a document) may, but need not, correspond to a file. A document may be stored in a portion of a file that holds other documents, in a single file dedicated to the document in question, in multiple coordinated files, or in a database. Examples of electronic documents include web pages, word processing documents, electronic mail messages, Short Message Service (SMS) messages, and which contain recognizable text, and KML data. KML is a file format used to display geographic data in an Earth browser such as Google Earth, Google Maps, and Google Maps for mobile. KML uses a tag-based structure with nested elements and attributes and is based on the eXtensible Markup Language (XML) standard. Documents can include text in one or more programming, markup and natural languages. Other types of documents are possible, however.

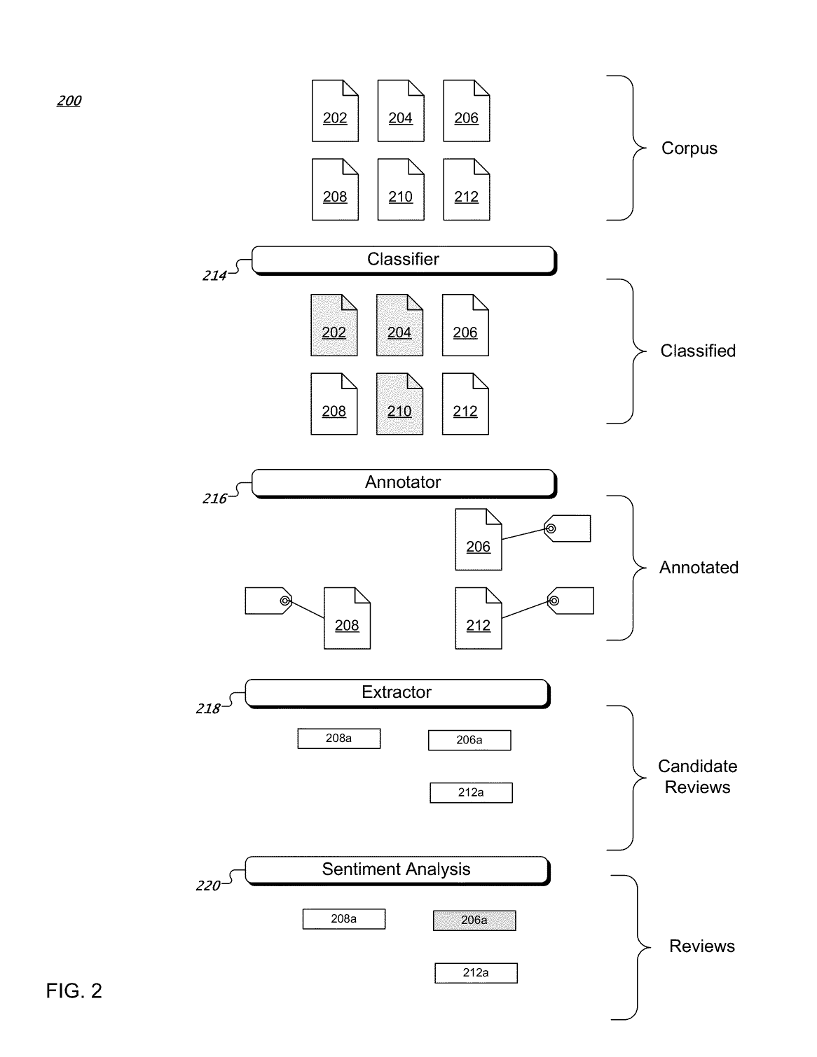

By way of illustration, review 112 was automatically extracted from document 102. Review extraction is described further below in regards to FIG. 2. Document 102 includes reviews of San Francisco coffee houses. The first review 102a in document 102 pertains to Mary's Coffee House. Document 102 portion 102b is entity identifying information which includes an entity name “Bob & Bob's Coffee” and an entity address “3493 Main Street”. In some implementations, different pieces of entity information are correlated with each other to establish that the information points to a specific entity. Entity identification information is described further below in regards to FIG. 2. The review of Bob & Bob's Coffee appears in document 102 portion 102d which follows the entity identifying information 102b. The review 102d is associated with the entity Bob & Bob's Coffee because, for example, there is no intervening entity identifying information between the review 102d and portion 102b. Other ways of associating a review with an entity are possible.

In further implementations, other relevant information that indicates that the document or part of the document refers to a given business entity can be used. For example, phone numbers on the page (usually combined with name and/or address) can be used to identify a business entity. Other documents that link to a document can also be used to identify a business entity. In particular, the anchor texts of links in other documents that point to a document, or the textual content near those links (or even the content of the entire document that links to a document) can be analyzed to determine if they contain entity identifying information. In some implementations, click information from a search engine that associates a query (e.g., “Bob & Bob's Coffee”) with a result document can be used to infer that a document which is clicked on (e.g., selected by a mouse or other input device) by users as a result for a query probably refers to the entity in the query if the number of clicks is high enough.

Other information can be located in the document 102 and associated with the reviews the information pertains to. For instance, following the entity identification information 102b is a star rating 102c. Rating codes, such as 102c, serve to summarize a review of an entity and come in various forms such as graphical (e.g., stars or other images), numerical (e.g., “7 out of 10”), and textual (e.g., “excellent” or “mediocre”). Authors of reviews, as well as review titles, dates of reviews, and identification of the documents or domains in which the reviews appear (e.g., a uniform resource locator or directory path) can also be optionally associated with the reviews to which they pertain. In addition, images and videos that occur in a document can be associated with a review and later presented as part of the review (e.g., in document 104).

The portions of document 102 that serve to review Bob & Bob's Coffee are extracted and inserted into document 104, optionally with formatting changes and/or language translation. For example, the rating information 102c appears as 112d, and the review 102d appears as 112e. In addition, an author 112a of the review, the domain 112b of the document 102, and the date of the review 112c are included.

Review 114 was extracted from document 106. The entity identifying information in document 106 includes an entity name 106a “B & B's Coffee” and an address 106b. Proceeding the review 106d is a title 106c “Great Coffee!”. Both the review 106d and its associated title 106c are included in the review 114. The entity name does not match the name associated with the address, i.e., “Bob & Bob's Coffee”, but because of the similarity between the two names and the fact that the entity address 106b is the same for both, it can be deduced that the entity in question is “Bob & Bob's Coffee”. In some implementations, this is accomplished with a clustering algorithm. Different sources of entity identifying information are crossed in order to group together all information about a given business in the same cluster. There are different similarity measures for the different entity information (e.g., entity name, entity address, and so on). By way of illustration, if the entity name and the phone numbers for two sets of entity identifying information are the same, but address information is slightly different (say 3493 Main Street and 3495 Main Street, for example), the two sets of entity identifying information would be considered the same entity. In further implementations, a canonicalization process converts each kind of entity identifying information into a standard form. For example, “3493 Main Street” and “3493 Main St.” are the same, but the latter address form would be converted into the former. The same applies to entity names. The name “B&B” is a synonym for “Bob & Bob's”.

FIG. 2 illustrates an example process for entity review extraction. For example, documents 202, 204, 206, 208, 210 and 212 are submitted to a classifier process 214. The classifier identifies documents that potentially contain entity reviews or, in some implementations, links to entity reviews. In various implementations, the classifier 214 is implemented as a supervised learning method such as, for example, using a Support Vector Machine (SVM), a decision tree, or a k-NN classifier. By way of illustration, the classifier 214 can be trained using training data that includes documents of varying formats with and without reviews so that the classifier can learn how to differentiate between them.

In some implementations, the classifier 214 can be implemented based on unsupervised methods. For instance, unsupervised classifiers execute by means of an automatic process that does not require human interaction to manually prepare training sets. In further implementations, the classifier 214 can use a text matching algorithm, for example, to locate specific keywords that indicate whether a document contains a review or not. Or the classifier 214 can define attributes and a ranking function to define rewards and penalties to documents that contain (or do not contain) each of the attributes. In further implementations, the classifier 214 can use hybrid methods that combine supervised and unsupervised approaches to classification. Other classifiers are possible, however.

Returning to the illustration at hand, documents 208, 206 and 212 have been identified by the classifier 214 as potentially containing reviews and are provided as input to an annotator process 216. The annotator 216 locates entity identifying information in its input documents. The annotations can be embedded in the documents or stored apart from the documents. In some implementations, the annotator 216 is implemented as a parser that is programmed to match text patterns resembling entity names, telephone numbers, street addresses, and geographic coordinates, for example. Other types of annotators are possible. Each type of information identified in a document is tagged with a type (e.g., name, telephone number or address) along with its starting and ending locations in the document. In further implementations, entity information can be extracted from images that are embedded in or linked to by documents. Text in images can be extracted using optical character recognition techniques and parsed to determine if the text contains entity identifying information. Object recognition techniques can be used to identify landmarks or other objects in images that can be used to possibly identify an approximate or specific geographic location (e.g., the Eiffel tower would indicate Paris as an approximate location).

In some implementations, formatting errors and incomplete information are allowed in entity identification information. Formatting errors can be corrected based on heuristics that correct the format of the information. In some cases, missing information from entity identification information in a document can be deduced by looking at other entity identifying information in the document. If an area code is missing from a telephone number, for example, the area code can be found based on address information such as a city or zip code. Similarly, if some portion of address information is partial or incorrect, a telephone number can be used to look up the business entity associated with that number in a database of business entities and the matching entity's address can be used to correct the address information. Other techniques for correcting formatting errors and supplying missing information are possible.

Once the documents (e.g., 206, 208 and 212) have been annotated, they are provided as input to an extractor process 218 which extracts candidate reviews from them. In various implementations, text surrounding entity identifying information is parsed by the extractor 218 to determine if the text contains any candidate reviews. In some implementations, markup language annotations or tags (e.g., Hypertext Markup Language tags) serve as delimiters for the candidate reviews. In further implementations, a candidate review lies between two markup language tags without any intervening markup language tags other than character formatting markup language tags (e.g., <b>, <font>, <br>, <p>, <strong>, and so on). These strategies can be combined. For example, a first rough segmentation can be performed based on a portion of the document's proximity to entity identifying information, and then a more thorough segmentation of that portion can be performed based on html tags within the portion. In some implementations, other tags may be considered acceptable as exceptions to delimiters. For example, a complete editorial review can span an entire page (or many paragraphs), and additional information such as images, links or videos might be placed together with the review text. In this case, the <img> and the <a> tags would not to be considered review delimiters.

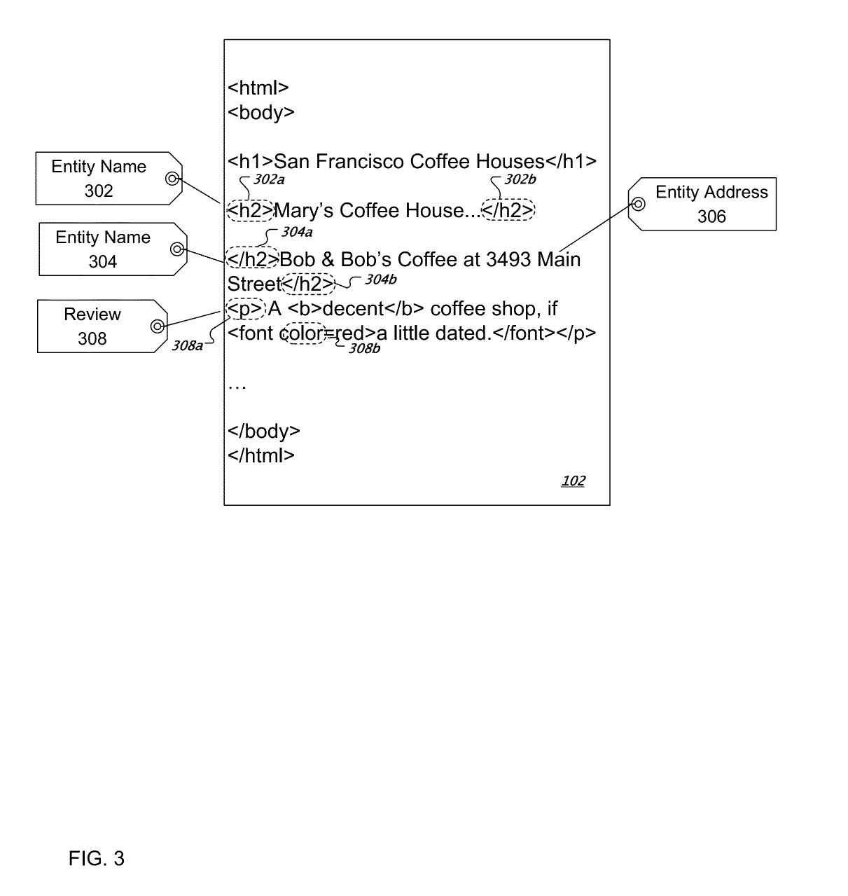

For example, FIG. 3 illustrates a hypertext markup language document 102. The document 102 includes pairs of tags: 302a and 302b, 304a and 304b, and 308a and 308b. The first two pairs delineate text that contains entity identifying information such as entity names (302, 304) and an entity address 306. The tag pair 308a and 308b will be extracted as containing a candidate review because the text is not entity identifying information and there are no intervening tags other than formatting tags <b> and <font>. Even though there are tags inside the review, the extractor 218 is able to split the text correctly. In other implementations, the extractor 218 can utilize a parser that is tailored to the structure of documents in a given domain.

The extractor 218 can also identify other information in a document that is associated with an extracted review such as a review title (e.g., 114a), a review rating code (e.g., 102c), an author of the review (e.g., 112a), and the date of a review (e.g., 112c). The URL of the document containing the review or the domain of the document (e.g., 112b) can also be associated with the review, as can images and videos in the document. This information usually occurs before or after a candidate review. The extractor 218 can identify this information using one or more additional parsers or heuristics that can be used to determine whether a string of text or an image contains a title, a rating code, an author's name, or a date.

In some implementations owner opening messages (so-called self-reviews), which are reviews clearly written by a business entity owner, are not extracted. The extractor 218 can detect self-reviews in some cases by determining if the document's location (e.g., URL) is an authority page for a business entity such as the official page of that business on the web. Reviews that appear on authority pages for a business entity are most likely self-reviews. Also, expressions used in the review which appear to be from a proprietor's perspective, such as “we have”, “we offer” or “our pasta”, tend to indicate that the review is a self-review. Finally, the text format and location of the text in the document's page structure can indicate that a review is a self-review. For example, if there is a review section of the document separated from the section where this review is, then there is a higher probability of the review being a self-review. In further implementations, self-reviews are extracted but designated as such in the web page 104.

In some implementations, the extractor 218 identifies reviews by locating meta-information in documents. There are some standard formats that webmasters can use to provide structured information to applications such those described herein. One of these standards is the hReview format, which consist of special tags that inform about the existence of a review. The tags (title, author, rating, and so on) are structured as well, so the extractor 218 can easily extract the information. Another standard is the hCard format, which contains name, address, and phone of a business listing, which can be used as to locate entity identifying information. Other formats and standards are possible, however.

The extracted candidate reviews 206a, 208a and 212a are provided to a sentiment analysis process 220 which analyzes each of the individual review candidates resulting from the previous process in relation to the sentiment it contains. The objective of the sentiment analysis 220 is to detect how much sentiment each of the candidate reviews contains, and filter out those whose sentiment magnitude is lower than a given empirically-obtained threshold. This approach eliminates candidate reviews that do not contain any review: the probability that a non-review in a classified document contains a sentiment magnitude above a high threshold is very low. In some implementations, a metric is used to determine whether the sentiment magnitude is satisfactory. The metric can be based on a threshold value for the magnitude, properties of the review (e.g., length, natural language, web domain of the document containing the review, and so on), or combinations of these.

Sentiment is generally measured as being positive, negative, or neutral (i.e., the sentiment is unable to be determined). In some implementations, if a review has both positive sentences and negative sentences, and their sentiment is substantially equal in magnitude, then the conclusion is that the review has mixed sentiment. This is different from neutral sentiment—neutral sentiment implies that there is not enough evidence of sentiment in the review. In some implementations, sentiment analysis identifies positive and negative words occurring in a candidate review and uses those words to calculate the magnitude (positive or negative) indicating the overall sentiment expressed by the candidate review. In some implementations, a domain-specific sentiment analysis is performed. For example the word “small” usually indicates positive sentiment when describing a portable electronic device, but can indicate negative sentiment when used to describe the size of a portion served by restaurant. Thus, words that are positive in one domain can be negative in another. Moreover, words which are relevant in one domain may not be relevant in another domain. For example, “battery life” may be a key concept in the domain of portable music players but be irrelevant in the domain of restaurants. An example of a such sentiment analyzer is found in U.S. patent publication no. 2009/0125371, Ser. No 11/844,222, entitled DOMAIN-SPECIFIC SENTIMENT CLASSIFICATION, filed Aug. 23, 2007, by Neylon et al.

In some implementations, a document scoring module within the sentiment analysis process 220 scores documents to candidate reviews the magnitude and polarity of the sentiment they express. In one embodiment, the document scoring module includes one or more classifiers. These classifiers include a lexicon-based classifier. The lexicon-based classifier uses a domain-independent sentiment lexicon to calculate sentiment scores for candidate reviews. The scoring performed by the lexicon-based classifier looks for n-grams from a lexicon that occur in the candidate reviews. For each n-gram that is found, the lexicon-based classifier determines a score for that n-gram. The sentiment score for the candidate review is the sum of the scores of the n-grams occurring within it.

An n-gram in the lexicon has an associated score representing the polarity and magnitude of the sentiment it expresses. For example, “hate” and “dislike” both have negative polarities, and “hate” has a greater magnitude than “dislike”. The part of speech that an n-gram represents is classified and a score is assigned based on the classification. For example, the word “model” can be an adjective, noun or verb. When used as an adjective, “model” has a positive polarity (e.g., “he was a model student”). In contrast, when “model” is used as a noun or verb, the word is neutral with respect to sentiment. An n-gram that normally connotes one type of sentiment can be used in a negative manner. For example, the phrase “This meal was not good” inverts the normally-positive sentiment connoted by “good.” In some implementations, a score is influenced by where the n-gram occurs in the candidate review. In one embodiment, n-grams are scored higher if they occur near the beginning or end of a review because these portions are more likely to contain summaries that concisely describe the sentiment described by the remainder of the review.

Other types of sentiment analysis are possible, however. Returning to the illustration at hand, the output of the sentiment analysis process 220 finds that only two candidate reviews (208a and 212a) have sentiment magnitude scores which exceed the threshold.

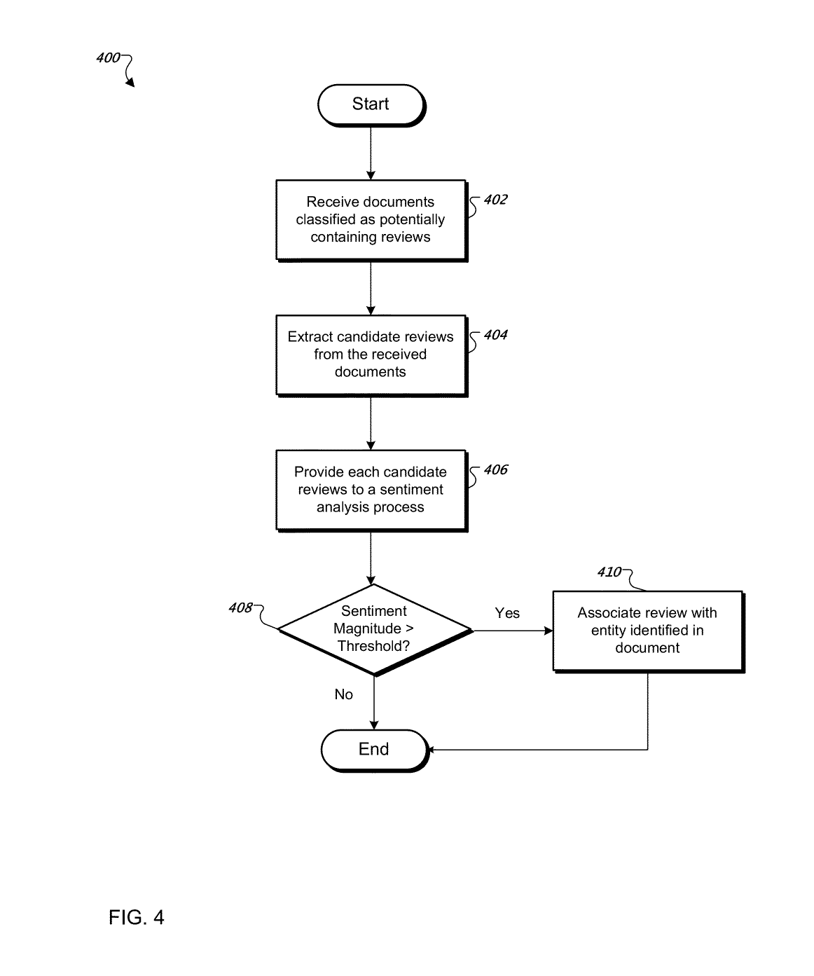

FIG. 4 is a flow diagram of an example technique for entity review extraction. Documents identified as containing potential reviews of entities (e.g., by the classifier 214) are received (402). Candidate reviews are then extracted from the received documents (e.g., by the extractor 218) based on, in some implementations, the location of entity identifying information as indicated by the annotator 216, for example (404). Reviews can be extracted also based on the structure of a document (e.g., HTML tags). The candidate reviews are then provided to a sentiment analysis process (e.g., sentiment analysis process 220) which calculates a sentiment magnitude for each of the candidate reviews based on words in the reviews (406). Candidate reviews having a sentiment magnitude above a threshold (408) are associated with an entity identified in the document from which the candidate review was extracted (410).

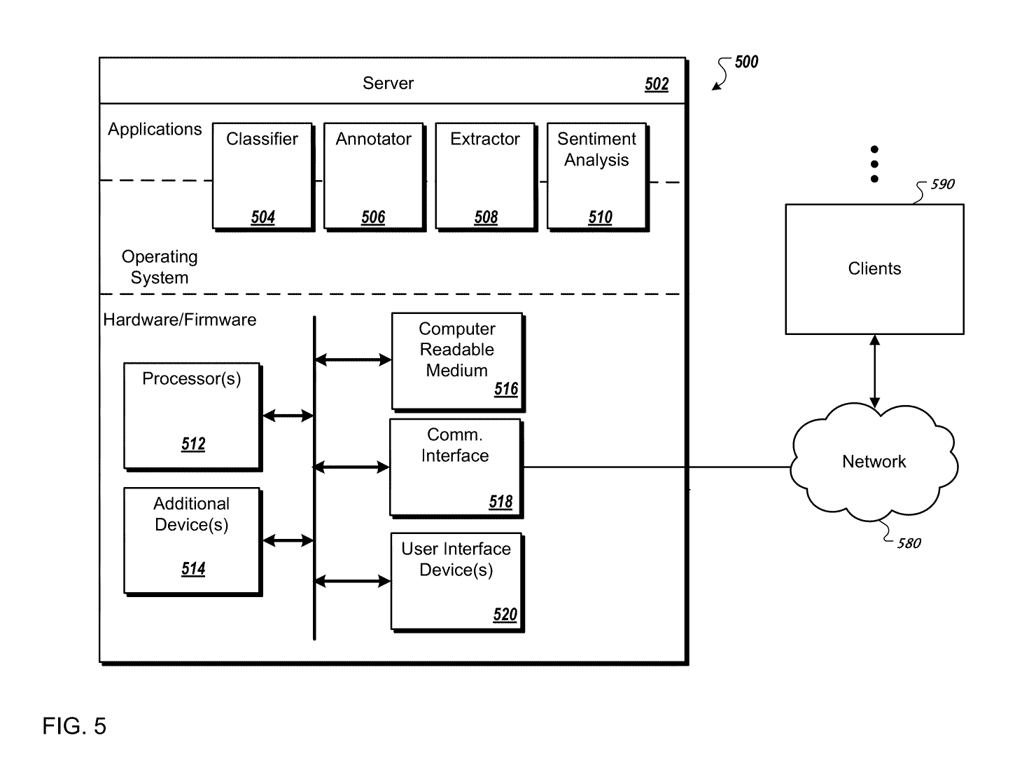

FIG. 5 is a schematic diagram of an example system configured to perform entity review extraction. The system generally consists of a server 502. The server 502 is optionally connected to one or more user or client computers 590 through a network 580. The server 502 consists of one or more data processing apparatus. While only one data processing apparatus is shown in FIG. 5, multiple data processing apparatus can be used. The server 502 includes various modules, e.g. executable software programs, including a classifier 504 for classifying documents as potentially containing reviews, an annotator 506 for annotating entity identifying information in documents, an extractor 508 for extracting candidate reviews from documents, and a sentiment analysis module 510 for determining the sentiment magnitude of the candidate reviews. Each module runs as part of the operating system on the server 502, runs as an application on the server 502, or runs as part of the operating system and part of an application on the server 502, for instance. Although several software modules are illustrated, there may be fewer or more software modules. Moreover, the software modules can be distributed on one or more data processing apparatus connected by one or more networks or other suitable communication mediums.

The server 502 also includes hardware or firmware devices including one or more processors 512, one or more additional devices 514, a computer readable medium 516, a communication interface 518, and one or more user interface devices 520. Each processor 512 is capable of processing instructions for execution within the server 502. In some implementations, the processor 512 is a single or multi-threaded processor. Each processor 512 is capable of processing instructions stored on the computer readable medium 516 or on a storage device such as one of the additional devices 514. The server 502 uses its communication interface 518 to communicate with one or more computers 590, for example, over a network 580. Examples of user interface devices 520 include a display, a camera, a speaker, a microphone, a tactile feedback device, a keyboard, and a mouse. The server 502 can store instructions that implement operations associated with the modules described above, for example, on the computer readable medium 516 or one or more additional devices 514, for example, one or more of a floppy disk device, a hard disk device, an optical disk device, or a tape device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-27. (canceled)

28. A method for obtaining a review of an entity, comprising:
receiving a document;
identifying text in the document that matches a text pattern for the entity;
extracting an entity review from the document by extracting text that surrounds the identified text;
identifying one or more n-grams in the entity review that occur in a sentiment lexicon, the sentiment lexicon including a plurality of n-grams and associated sentiment scores;
determining a sentiment score for the entity review from a sum of the scores of the one or more identified n-grams that occur in the sentiment lexicon; and
storing the entity review and the sentiment score in a record for the entity.

29. The method of claim 28, wherein the text pattern contains at least one of the entity name, telephone number, or street address.

30. The method of claim 28, wherein determining a sentiment score for the entity review further comprises increasing the sentiment scores for identified n-grams near the beginning or end of the entity review.

31. The method of claim 28, further comprising determining that a magnitude of the sentiment score for the entity review exceeds a threshold.

32. The method of claim 28, wherein the document comprises a web page, a word processing document, an electronic mail message, a short message service message, or a KML document.

33. The method of claim 28, wherein identifying text in the document that matches a text pattern for the entity further comprises:
extracting text from images that are embedded in or linked to the document using optical character recognition; and
determining that the extracted text matches the text pattern for the entity.

34. A system for obtaining a review of an entity, comprising:
one or more memory devices storing computer instructions; and
one or more processors, executing the instructions stored on the one or more memory device, in order to perform the following method:
receiving a document;
identifying text in the document that matches a text pattern for the entity;
extracting an entity review from the document by extracting text that surrounds the identified text;
identifying one or more n-grams in the entity review that occur in a sentiment lexicon, the sentiment lexicon including a plurality of n-grams and associated sentiment scores;
determining a sentiment score for the entity review from a sum of the scores of the one or more identified n-grams that occur in the sentiment lexicon; and
storing the entity review and the sentiment score in a record for the entity.

35. The system of claim 34, wherein the text pattern contains at least one of the entity name, telephone number, or street address.

36. The system of claim 34, wherein determining a sentiment score for the entity review further comprises increasing the sentiment scores for identified n-grams near the beginning or end of the entity review.

37. The system of claim 34, wherein the method further comprises determining that a magnitude of the sentiment score for the entity review exceeds a threshold.

38. The system of claim 34, wherein the document comprises a web page, a word processing document, an electronic mail message, a short message service message, or a KML document.

39. The system of claim 34, wherein identifying text in the document that matches a text pattern for the entity further comprises:
extracting text from images that are embedded in or linked to the document using optical character recognition; and
determining that the extracted text matches the text pattern for the entity.

40. A non-transitory computer readable storage medium comprising program instructions stored thereon that are executable by one or more processors to perform the following method:
receiving a document;
identifying text in the document that matches a text pattern for the entity;
extracting an entity review from the document by extracting text that surrounds the identified text;
identifying one or more n-grams in the entity review that occur in a sentiment lexicon, the sentiment lexicon including a plurality of n-grams and associated sentiment scores;
determining a sentiment score for the entity review from a sum of the scores of the one or more identified n-grams that occur in the sentiment lexicon; and
storing the entity review and the sentiment score in a record for the entity.

41. The medium of claim 40, wherein the text pattern contains at least one of the entity name, telephone number, or street address.

42. The medium of claim 40, wherein determining a sentiment score for the entity review further comprises increasing the sentiment scores for identified n-grams near the beginning or end of the entity review.

43. The medium of claim 40, wherein the method further comprises determining that a magnitude of the sentiment score for the entity review exceeds a threshold.

44. The medium of claim 40, wherein the document comprises a web page, a word processing document, an electronic mail message, a short message service message, or a KML document.

45. The medium of claim 40, wherein identifying text in the document that matches a text pattern for the entity further comprises:
extracting text from images that are embedded in or linked to the document using optical character recognition; and
determining that the extracted text matches the text pattern for the entity.
